(19) United States
(12) Patent Application Publication
(10) Pub. No.: US 2024/0426661 A1
(43) Pub. Date: Dec. 26, 2024

(54) METHOD FOR CALIBRATING A SPECTROMETER DEVICE

(71) Applicant: TRINAMIX GMBH, Ludwigshafen am Rhein (DE)

(72) Inventors: Sebastian Stephan WINKLER, Ludwigshafen am Rhein (DE); Henning ZIMMERMANN, Ludwigshafen am Rhein (DE); Andre HORSAK, Ludwigshafen am Rhein (DE); Robert LOVRINCIC, Ludwigshafen am Rhein (DE); Felix SCHMIDT, Ludwigshafen am Rhein (DE); Patrick SCHINDLER, Ludwigshafen am Rhein (DE)

(21) Appl. No.: 18/684,400

(22) PCT Filed: Sep. 14, 2022
(86) PCT No.: PCT/EP2022/075497

§ 371 Date: Feb. 16, 2024

(30) Foreign Application Priority Data
Sep. 15, 2021 (EP) 21196920.9

(51) Int. Cl. G01J 3/02; G01J 3/28

(52) U.S. Cl. CPC G01J 3/027; G01J 2003/283

(57) ABSTRACT

Disclosed herein is a method for calibrating a spectrometer device. The method includes the following steps:
a) illuminating at least one detector device of the spectrometer device with at least one broadband light source through at least one narrow band pass filter having a plurality of predetermined transmission bands;
b) generating, by using the detector device, a plurality of detector signals depending on the illumination of step a);
c) determining at least one item of wavelength calibration information, where the item of wavelength calibration information includes at least one assignment assigning wavelengths of incident light to corresponding photosensitive elements being responsive to these wavelengths; and
d) determining at least one item of stray light calibration information based on the plurality of detector signals.

Further disclosed herein are a system for calibrating a spectrometer device, a computer program and a computer-readable storage medium.

### TECHNICAL FIELD

The present invention relates to a method for calibrating a spectrometer device and to a system for calibrating a spectrometer device. Further, the present invention relates to a computer program and a computer-readable storage medium for performing the method for calibrating a spectrometer device. The method and devices can, in particular, be used for calibrating spectrometer devices used for investigation in the infrared spectral region, specifically in the near infrared and the mid infrared spectral regions. However, other spectrometer devices are also feasible.

### BACKGROUND ART

Spectrographic methods are widely used in research, industry and customer applications, enabling multiple applications such as optical analysis and/or quality control. Use cases can be found for food, farming, pharma, medical, life sciences and many more. Various methods are available, such as photometry, absorption, fluorescence and Raman spectrometry, enabling qualitative and/or quantitative sample analysis. These methods usually involve mapping of spectral information, such as an irradiance of a sample, at a specific wavelength onto a specific physical section of the spectrographic device, for example detector pixels, time intervals or others.

Generally, spectrographic methods require for a successful application-reliable performance of the spectrographic devices having negligible fluctuation, in particular when comparing measurements from various spectrographic devices with each other. Specifically, spectral data for a specific sample should be at least similar or identical for various spectrographic devices of the same type.

For spectrographic devices, two system properties may generally be crucial for a reliable performance: Firstly, wavelength calibration may be of great importance, meaning that the displayed or measured wavelength is, at least within a given level of tolerance, correct. In pixelated spectrographic devices, using photosensitive pixels being assigned to specific wavelengths, wavelength calibration may comprise mapping individual pixels or time domains for Fourier-transformation based spectrographs onto its respective wavelength. Secondly, cross-talk calibration, also known as stray light calibration, may be of significant importance. In ideal operation, a spectrographic device maps spectral information of a sample to be studied onto several signal channels. Ideally, one single channel may contain information from the sample in a very narrow spectral range and may not include spectral information outside of this spectral range, i.e. a one to one mapping of spectral information onto output channels. However, undesired effects in the spectrographic device, such as diffusive scattering on surfaces and/or diffraction, can cause a cross-talk between multiple channels of the spectrograph. This may cause spectral information in a narrow spectral range to affect multiple output channels. The stray light calibration may comprise information about an influence of one detector signal at a certain wavelength by another signal at another wavelength.

Further calibrations of the spectrographic device, such as sensitivity calibrations of the spectrographic device, are often not required, in particular when relative measures, i.e. absorption and/or reflection of samples, shall be determined.

Various methods for wavelength and/or stray light calibrations are known in the art. For example, M. E. Schaepman and S. Dangel describe in “Solid laboratory calibration of a nonimaging spectroradiometer”, Applied Optics, volume 39, number 21, 2000, a laboratory calibration of a nonimaging spectroradiometer based on a measurement plan. The individual calibration steps include characterization of the signal-to-noise ratio, the noise equivalent signal, the dark current, the wavelength calibration, the spectral sampling interval, the nonlinearity, directional and positional effects, the spectral scattering, the field of view, the polarization, the size-of-source effects, and the temperature dependence of a particular instrument.

C. Tseng, J. F. Ford, C. K. Mann and T. J. Vickers: “Wavelength Calibration of a Multichannel Spectrometer”, Applied Spectroscopy, volume 47, number 11, 1993, discloses an automated procedure for wavelength calibration of multichannel spectrometers. The procedure uses Neon atomic lines as wavelength standards.

A. K. Gaigalas, L. Wang, H.-J. He and P. DeRose: “Procedures for Wavelength Calibration and Spectral Response Correction of CCD Array Spectrometers”, Journal of Research of the National Institute of Standards and Technology, volume 114, number 4, 2009, describes a procedure for acquiring a spectrum of an analyte over an extended range of wavelengths and validating the wavelength and intensity assignments.

US 2020/0056939 A1 describes a method of calibrating a spectrometer module. The method includes performing measurements using the spectrometer module to generate wavelength-versus-operating parameter calibration data for the spectrometer module, performing measurements using the spectrometer module to generate optical crosstalk and dark noise calibration data for the spectrometer module, and performing measurements using the spectrometer module to generate full system response calibration data, against a known reflectivity standard, for the spectrometer module. The method further includes storing in memory, coupled to the spectrometer module, a calibration record that incorporates the wavelength-versus-operating parameter calibration data, the optical crosstalk and dark noise calibration data, and the full system response calibration data, and applying the calibration record to measurements by the spectrometer module.

CN 103226095 B discloses a method for real-time online wavelength calibration of a spectrometer using a sulfur dioxide standard gas inside a DOAS flue gas analyzer.

U.S. Pat. No. 7,839,502 B2 describes methods for wavelength calibration of spectrometers. The methods are based on the principle of a stepwise relative shift of corresponding measured-value blocks of a model and calibration spectrum where a correlation value is calculated for each shift step. A shift value is determined for each measured-value block at which the correlation value reaches an optimum. A value pair consisting of a position marker of the measured-value block and the associated shift value is determined for each measured-value block. These value pairs represent the design points for fitting to a suitable assignment function. Coefficients obtained in this manner can be used directly as coefficients of a wavelength assignment or be combined with the coefficients of an existing first wavelength assignment in that they for example replace or are offset against the coefficients of an existing first wavelength assignment.

C. Pope and A. Baumgartner: “Light source for stray light characterisation of EnMAP spectrometers”, Proceeding of SPIE 11151, Sensors, Systems, and Next-Generation Satellites XXIII, 1115123, 2019, discloses a light source developed for stray light characterization of satellite's spectrometers and it's use to characterize the in-band, in-field stray light.

Y. Zong, S. W. Brown, B. C. Johnson, K. R. Lykke and Y. Ohno: “Simple spectral stray light correction method for array spectroradiometers”, Applied Optics, volume 45, number 6, 2006, describes a method to correct a spectroradiometer's response for measurement errors arising from the instrument's spectral stray light. By characterizing the instrument's response to a set of monochromatic laser sources that cover the instrument's spectral range, one obtains a spectral stray light signal distribution matrix that quantifies the magnitude of the spectral stray light signal within the instrument. By use of these data, a spectral stray light correction matrix is derived and the instrument's response can be corrected with a simple matrix multiplication.

A. Kreuter and M. Blumthaler: “Stray light correction for solar measurements using array spectrometers”, Review of Scientific Instruments, 80, 096108, 2009, discloses a stray light matrix correction method for array spectrometers, specifically tailored for solar spectral measurements. A stray light distribution function based on a single laser line measurement is approximated by an analytical function using three parameters only. This function is the basis for the stray light correction matrix. One cutoff filter is then used to adjust an offset parameter such that stray light corrected data are spectrally flat and around zero below the cutoff wavelength.

M. E. Feinholz, S. J. Flora, S. W. Brown, Y. Zong, K. R. Lykke, M. A. Yarbrough, B. C. Johnson and D. K. Clark: “Stray light correction algorithm for multichannel hyperspectral spectrographs”, Applied Optics, volume 51, number 16, 2012, describes an algorithm that corrects a multichannel fiber-coupled spectrograph for stray or scattered light within the system. The algorithm, based on characterization measurements using a tunable laser system, can be extended to correct for finite point-spread response in imaging systems.

Y. Zong, S. W. Brown, B. C. Johnson, K. R. Lykke and Y. Ohno: “Correction of stray light in spectrographs: implications for remote sensing”, Proceeding of SPIE 5882, Earth Observing Systems X, 588201, 2005, discloses a method to correct stray-light errors in a spectrograph. By measuring a set of monochromatic laser sources that cover the instrument's spectral range, the instrument's stray-light property is characterized and a stray-light correction matrix is derived.

WO 2018/085841 A1 discloses a calibration of hyperspectral sensors and camera systems. More specifically, apparatus and methods are disclosed which are used to measure the characteristics of camera systems based on active pixel sensors with Fabry-Perot filters deposited directly onto the active pixel array and to improve the usage of such systems in various applications, including agriculture, medicine, and other fields of use that benefit from a better calibrated hyperspectral system.

US 2018/224334 A1 discloses spectrophotometers and spectroscopy processes that can provide for in-line calibration at every spectral acquisition as well as for continuous response correction during sample processing. The spectrophotometers include multiple polychromatic light sources that include characteristic emission spectra for use as an internal wavelength drift calibration system that is independent of environmental factors. Correction functions provided by the internal calibration process can be applied continuously and across an entire sample spectrum. The intensity response of each spectrometer in a spectrophotometer can also be monitored and continuously corrected for stray light, dark current, readout noise, etc.

Despite the advantages achieved by known methods and devices, several technical challenges remain. Specifically, known wavelength and stray light calibrations are usually performed independently in a laboratory or during factoring, using delicate and costly equipment, such as pen ray lamps, standard lamps using Argon or monochromator systems. Each calibration may be obtained by an independent process and independent measurement setups, respectively. The wavelength calibration is normally based on an atomic gauge, i.e. radiation lines of various atomic species may be used as a universal standard for the wavelength calibration. Typical sources are Helium Neon lasers, Argon and Mercury lamps. Alternatively, rare-earth calibration standards are available. The atomic emission spectrum may be recorded and the position is compared to reference data, e.g. from central standardization and gauge institutions. The stray light correction may generally be identified and/or quantified using narrow band light sources, such as light from a monochromator or a tunable laser. In most cases, separate light sources for each output channel of the spectrographic device may have to be used.

### Problem to be Solved

It is therefore desirable to provide methods and devices which at least partially address above-mentioned technical challenges regarding calibration of spectrometer devices. Specifically, a method and a system for calibrating a spectrometer device shall be proposed which provide high flexibility for accurately calibrating spectrometer devices by using a simple setup at low cost and low effort.

### SUMMARY

This problem is addressed by a method for calibrating a spectrometer device, by a system for calibrating a spectrometer device and by a computer program and a computer-readable storage medium with the features of the independent claims. Advantageous embodiments which might be realized in an isolated fashion or in any arbitrary combinations are listed in the dependent claims as well as throughout the specification.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, a method for calibrating a spectrometer device is disclosed.

The term “spectrometer device” as used herein is a broad term and is to be given its ordinary and customary meaning to a person of ordinary skill in the art and is not to be limited to a special or customized meaning. The term specifically may refer, without limitation, to a device capable of optically analyzing at least one sample, thereby generating at least one item of information on at least one spectral property of the sample. Specifically, the term may refer to a device which is capable of recording a signal intensity with respect to a corresponding wavelength of a spectrum or a partition thereof, such as a wavelength interval, wherein the signal intensity may, preferably, be provided as an electrical signal which may be used for further evaluation. An optical element, specifically comprising at least one wavelength-selective element, such as an optical filter and/or a dispersive element, may be used for separating incident light into a spectrum of constituent wavelength components whose respective intensities are determined by employing a detector device. In addition, a further optical element may be used which can be designed for receiving incident light and transferring the incident light to the optical element. The spectrometer device, generally, may be operable in a reflective mode and/or may be operable in a transmissive mode. For possible embodiment of the spectrometer device, reference is made to the description of the spectrometer device as will be outlined in further detail below.

The term “calibrating”, the process or the result of the process also being referred to as “calibration”, as used herein is a broad term and is to be given its ordinary and customary meaning to a person of ordinary skill in the art and is not to be limited to a special or customized meaning. The term specifically may refer, without limitation, to the process of at least one of determining, correcting and adjusting measurement inaccuracies at the spectrometer device. Thus, the result of the calibration process, often also referred to as the “item of calibration information”, may also be or comprise at least one item of information on the result of the calibration process, such as a calibration function, a calibration factor, a calibration matrix or the like, e.g. for transforming one or more measured values into one or more calibrated or “true” values. Measurement inaccuracies may, as an example, arise from uncertainties in wavelength determination and/or from intrinsic and/or extrinsic interferences on measurement signals of the spectrometer device. Thus, as will be outlined in further detail below, calibrating the spectrometer device may comprise at least one of a wavelength calibration, a stray light calibration, a dark current calibration, a spectral bandwidth calibration, an intensity distribution calibration and a signal linearity calibration. The calibration, specifically each of the calibrations, may comprise at least one two-step process, wherein, in a first step, information on a deviation of a measurement signal of the spectrometer device from a known standard is determined, wherein, in a second step, this information is used for correcting and/or adjusting the measurement signal of the spectrometer device in order to reduce, minimize and/or eliminate the deviation. Thus, the calibration may comprise applying the item of calibration information, for example to a measurement signal and/or a measurement spectrum of the spectrometer device. A calibration of the spectrometer device may improve and/or maintain accuracy of measurements performed with the calibrated spectrometer device.

The method comprises the following steps which, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises the following steps:
a) illuminating at least one detector device of the spectrometer device with at least one broadband light source through at least one narrow band pass filter, specifically through a plurality of narrow band pass filters, having a plurality of predetermined transmission bands;
b) generating, by using the detector device, a plurality of detector signals depending on the illumination of step a), wherein the detector device comprises at least one optical element configured for separating incident light into a spectrum of constituent wavelength components and further comprising a plurality of photosensitive elements, wherein each photosensitive element is configured for receiving at least a portion of one of the constituent wavelength components and for generating a respective detector signal depending on the illumination of the respective photosensitive element by the at least one portion of the respective constituent wavelength component;
c) determining at least one item of wavelength calibration information, wherein the item of wavelength calibration information comprises at least one assignment assigning wavelengths, specifically wavelength bands, of incident light to corresponding photosensitive elements being responsive to these wavelengths, specifically assigning at least one of the photosensitive elements to each of the predetermined transmission bands, more specifically assigning one or more of pixel positions and/or identification numbers of the photosensitive elements to the respective predetermined transmission bands, specifically to each of the predetermined transmission bands; and
d) determining at least one item of stray light calibration information based on the plurality of detector signals, wherein the item of stray light calibration information comprises at least one signal distribution function, specifically at least one signal distribution matrix, the signal distribution function describing a distribution of responses of the photosensitive elements to incident light having a specific wavelength.

The term “broadband light source” as used herein is a broad term and is to be given its ordinary and customary meaning to a person of ordinary skill in the art and is not to be limited to a special or customized meaning. The term specifically may refer, without limitation, to a device emitting light in a broad spectral range, such as light having spectral width of at least 5 nm, specifically at least 10 nm, e.g. a spectral width of 10 nm to 2000 nm. For example, the broadband light source may comprise at least one incandescent lamp having a spectral radiance corresponding to blackbody radiation at a temperature in the range of from 2000 K to 3000 K, specifically at a temperature of 2700 K. However, other examples of the broadband light source are also feasible, as will be outlined in further detail below. The broad spectral range of the broadband light source may cover at least partially a spectral range of the spectrometer device, specifically the complete spectral range of the spectrometer device. For example, the broadband light source may emit light in a broad spectral range of 400 nm to 3000 nm. As used herein, the term “light”, generally, refers to a partition of electromagnetic radiation which is, usually, referred to as “optical spectral range” and which comprises one or more of a visible spectral range, an ultraviolet spectral range and an infrared spectral range. The terms “ultraviolet spectral” or “UV”, generally, refer to electromagnetic radiation having a wavelength of 1 nm to 380 nm, preferably of 100 nm to 380 nm. The term “visible”, generally, refers to a wavelength of 380 nm to 760 nm. The terms “infrared” or “IR”, generally, refer to a wavelength of 760 nm to 1000 μm, wherein a wavelength of 760 nm to 3 μm is, usually, denominated as “near infrared” or “NIR” while the wavelength of 3μ to 15 μm is, usually, denoted as “mid infrared” or “MidIR” and the wavelength of 15 μm to 1000 μm as “far infrared” or “FIR”. The broad spectral range of the broadband light source may comprise at least one of the visible spectral range, the ultraviolet spectral range and the infrared spectral range. Light used for the typical purposes of the present invention may, in particular, comprise light in the IR spectral range, specifically in at least one of the NIR or the MidIR spectral ranges, more specifically having a wavelength of 1 μm to 5 μm, even more specifically of 1 μm to 3 μm.

The term “band pass filter” as used herein is a broad term and is to be given its ordinary and customary meaning to a person of ordinary skill in the art and is not to be limited to a special or customized meaning. The term specifically may refer, without limitation, to an optical element configured for transmitting incident light having a wavelength within at least one specific spectral range, also referred to as “transmission band”, and for reflecting, absorbing and/or attenuating incident light having a wavelength outside the at least one specific spectral range, such as a wavelength above an upper threshold of the specific spectral range and/or a wavelength below a lower threshold of the specific spectral range. The term “predetermined” as used in the context of “predetermined transmission bands” may refer to a situation in which, when the narrow band pass filter is used for performing step a), the spectral range of its transmission bands are known. Specifically, the spectral range of the transmission bands of the narrow band pass filter may be known by using standards with known transmission characteristics, such as from a datasheet of the narrow band pass filter and/or by a preceding determination of the spectral range, for example by using a calibrated spectrometer device.

A width of the spectral ranges of the band pass filter, i.e. a spectral bandwidth of the transmission bands, may be lower than a spectral resolution of the spectrometer device, thus, rendering the band pass filter a “narrow band pass filter”. In the method according to the present invention, one narrow band pass filter having a plurality of transmission bands or, alternatively, a plurality of narrow band pass filters each having one transmission band, specifically being different from the transmission bands of the other narrow band pass filters, may be used.

As outlined above, the method comprises illuminating the detector device with the broadband light source through the narrow band pass filter, specifically through the plurality of narrow band pass filters. The term “illuminating” as used herein is a broad term and is to be given its ordinary and customary meaning to a person of ordinary skill in the art and is not to be limited to a special or customized meaning. The term specifically may refer, without limitation, to an action of actively or passively guiding light emitted from the broadband light source to the detector device. Specifically, illuminating the detector device through the narrow band pass filter, specifically through the plurality of narrow band pass filters, may refer to a situation in which the light emitted from the broadband light source is at least partially transmitted through the narrow band pass filter, specifically through the plurality of narrow band pass filters, before the detector device is illuminated.

The term “detector device” as used herein is a broad term and is to be given its ordinary and customary meaning to a person of ordinary skill in the art and is not to be limited to a special or customized meaning. The term specifically may refer, without limitation, to an arbitrary device or combination of devices capable of recording and/or monitoring incident light. The detector device may be responsive to incident illumination and may be configured for generating an electrical signal indicating an intensity of the illumination. The detector device may be sensitive in one or more of the visible spectral range, the ultraviolet spectral range or the infrared spectral range, specifically the near infrared spectral range (NIR). The detector device specifically may be or may comprise at least one optical sensor, e.g. an optical semiconductor sensor. As an example, specifically in case the detector device is sensitive in the infrared spectral range, such as in the near infrared spectral range, the semiconductor sensor may be or may comprise at least one semiconductor sensor comprising at least one material selected from the group consisting of PbS, PbSe, InGaAs, and extended-InGaAs. As an example, the detector device may comprise at least one photodetector such as at least one CCD or CMOS device. The detector device specifically may comprise at least one detector array comprising a plurality of pixelated sensors, wherein each of the pixelated sensors is configured to detect at least a portion of at least one of the constituent wavelength components. The detector device comprises at least one optical element and a plurality of photosensitive elements.

The term “optical element” as used herein is a broad term and is to be given its ordinary and customary meaning to a person of ordinary skill in the art and is not to be limited to a special or customized meaning. The term specifically may refer, without limitation, to an arbitrary element or a combination of elements suitable for one or more of transmitting, reflecting, deflecting or scattering light in a wavelength-dependent manner. The optical element may further be configured, specifically after separating incident light into the spectrum of constituent wavelength components, for transmitting the spectrum onto the plurality of photosensitive wavelength elements. Specifically, the wavelength-dependent transmission, reflections, deflection or scattering of incident light at the optical element may result in a spatial separation of the constituent wavelength components of the spectrum and, thus, may be transmitted directly or indirectly onto the plurality of photosensitive elements.

As outlined above, the optical element is configured for separating incident light into the spectrum of constituent wavelength components. The term “spectrum” as used herein is a broad term and is to be given its ordinary and customary meaning to a person of ordinary skill in the art and is not to be limited to a special or customized meaning. The term specifically may refer, without limitation, to a partition of the optical spectral range, in particular, the IR spectral range, especially at least one of the NIR or the MidIR spectral ranges, being investigated by the spectrometer device. Each part of the spectrum may be constituted by an optical signal which is defined by a signal wavelength and the corresponding signal intensity. Consequently, the term “constituent wavelength component” as used herein is a broad term and is to be given its ordinary and customary meaning to a person of ordinary skill in the art and is not to be limited to a special or customized meaning. The term specifically may refer, without limitation, to the optical signal forming part of the spectrum. Specifically, the optical signal may comprise the signal intensity corresponding to the respective wavelength or wavelength interval.

The term “photosensitive element” as used herein is a broad term and is to be given its ordinary and customary meaning to a person of ordinary skill in the art and is not to be limited to a special or customized meaning. The term specifically may refer, without limitation, to an individual optical sensor comprised by the detector device, wherein each optical sensor has at least one photosensitive area configured for recording a photoresponse of the photosensitive element by generating at least one output signal that depends on an intensity of a portion of one of the constituent wavelength components impinging on the particular photosensitive area. The at least one photosensitive area as comprised by each individual optical sensor may, especially, be a single, uniform area which is designated for receiving incident light impinging on the photosensitive area. The at least one output signal may, in particular, be used as the detector signal and can, preferably, be provided to an external evaluation unit for further evaluation.

Consequently, the term “detector signal” as used herein is a broad term and is to be given its ordinary and customary meaning to a person of ordinary skill in the art and is not to be limited to a special or customized meaning. The term specifically may refer, without limitation, to a signal generated by at least one detector, specifically to the at least one output signal of the photosensitive element. The at least one output signal may be selected from at least one of an electronic signal and an optical signal. The at least one output signal may be an analogue signal and/or a digital signal. The output signals for adjacent photosensitive elements can be generated simultaneously, or in a temporally successive manner. By way of example, during a row scan or a line scan, it can be feasible to generate a sequence of output signals which correspond to the series of the photosensitive elements which may be arranged in a line. In addition, the individual photosensitive elements may, preferably, be active pixel sensors which may be adapted to amplify the output signals prior to providing them as detector signals to the external evaluation unit. For this purpose, the photosensitive element may comprise one or more signal processing devices, such as one or more filters and/or analogue-digital-converters for processing and/or pre-processing the electronic signals.

As outlined above, the method comprises determining the at least one item of wavelength calibration information. The term “item of wavelength calibration information” as used herein is a broad term and is to be given its ordinary and customary meaning to a person of ordinary skill in the art and is not to be limited to a special or customized meaning. The term specifically may refer, without limitation, to at least one item of information generated by a process of at least one of determining, correcting and adjusting wavelength inaccuracies at the spectrometer device. The at least one item of information specifically may be or may comprise at least one of a calibration function, a calibration factor and a calibration matrix. The item of wavelength calibration information comprises the at least one assignment assigning wavelengths, specifically wavelength bands, of incident light to corresponding photosensitive elements being responsive to these wavelengths. As used herein, the term “wavelength band” may refer to a wavelength interval being assigned to photosensitive elements. Specifically, by determining the item of wavelength calibration information, it may be possible to assign a wavelength and/or a wavelength interval to at least one of the photosensitive element, specifically to each of the photosensitive elements, being illuminated by the constituent wavelength component of the spectrum, which specifically is separated and transmitted by the optical element to the respective photosensitive element. The item of wavelength calibration information, in particular the assignment, may be determined by mapping at least one of the photosensitive elements to the predetermined transmission bands of the narrow band pass filter, specifically of the plurality of narrow band pass filters.

The item of wavelength calibration information may specifically comprise at least one assignment assigning at least one of the photosensitive elements to each of the predetermined transmission bands, specifically assigning one or more of pixel positions and/or identification numbers of the photosensitive elements to the respective predetermined transmission bands, specifically to each of the predetermined transmission bands. The term “pixel position” as used herein is a broad term and is to be given its ordinary and customary meaning to a person of ordinary skill in the art and is not to be limited to a special or customized meaning. The term specifically may refer, without limitation, to an arbitrary item of location information of the photosensitive element in the detector device. The pixel information may describe a position of the photosensitive element in the detector device by using one or more of an absolute position information and a relative position information, specifically in one, two or even three dimensions. The term “identification number” as used herein is a broad term and is to be given its ordinary and customary meaning to a person of ordinary skill in the art and is not to be limited to a special or customized meaning. The term specifically may refer, without limitation, to a numerical or alpha-numerical item of information uniquely identifying each photosensitive element comprised by the detector device. For example, the photosensitive elements of the detector device may be numbered with respect to an order of appearance in the detector device. However, other options for identifying the photosensitive elements in the detector device are also feasible.

The term “assignment” as used herein is a broad term and is to be given its ordinary and customary meaning to a person of ordinary skill in the art and is not to be limited to a special or customized meaning. The term specifically may refer, without limitation, to an item of information relating a first item of information to a second item of information, for example by using a mathematical relation, such as a continuous function and/or a discrete function. Consequently, the process of “assigning” may refer to the process of relating the first item of information to the second item of information. Specifically, the assignment may relate the photosensitive element, in particular one or more of the pixel position and/or the identification number of the photosensitive element, to a wavelength and/or a wavelength band illuminating said photosensitive element.

As further outlined above, the method comprises determining the at least one item of stray light calibration information. The term “item of stray light calibration information” as used herein is a broad term and is to be given its ordinary and customary meaning to a person of ordinary skill in the art and is not to be limited to a special or customized meaning. The term specifically may refer, without limitation, to at least one item of information generated by a process of at least one of determining, correcting and adjusting stray light inaccuracies at the spectrometer device. The at least one item of information specifically may be or may comprise at least one of a calibration function, a calibration factor and a calibration matrix. Stray light may arise in the spectrometer device due to diffuse scattering on surfaces, diffraction, for example diffraction at the optical element, and/or other undesired effects. The item of stray light calibration information may comprise a signal distribution of stray light on the detector device, specifically on the plurality of photosensitive elements. Additionally, the item of stray light calibration information may comprise the determined signal distribution in a format such that a measurement signal, in particular a measurement signal of a sample to be analyzed, may be corrected and/or adjusted to minimize and/or eliminate adverse effects of stray light on the measurement signal.

The at least one item of stray light calibration information comprises the at least one signal distribution function, specifically the at least one signal distribution matrix, the signal distribution function describing a distribution of responses of the photosensitive elements to incident light having a specific wavelength. The term “signal distribution function” as used herein is a broad term and is to be given its ordinary and customary meaning to a person of ordinary skill in the art and is not to be limited to a special or customized meaning. The term specifically may refer, without limitation, to a mathematical function, such as a continuous function and/or a discrete function, describing a distribution of stray light, specifically a signal distribution of stray light, on the detector device. Specifically, the signal distribution function may comprise a signal distribution on the plurality of photosensitive elements for one of the constituent wavelength components of the spectrum. The item of stray light calibration information may comprise at least one signal distribution function for each of the constituent wavelength components of the spectrum. A plurality of signal distribution functions, specifically comprising one signal distribution function for each of the constituent wavelength components, may be recorded in a signal distribution matrix.

Consequently, the term “signal distribution matrix” as used herein is a broad term and is to be given its ordinary and customary meaning to a person of ordinary skill in the art and is not to be limited to a special or customized meaning. The term specifically may refer, without limitation, to a matrix having matrix elements a_{i,j}, i=1, . . . , n denoting the ith photosensitive element and j=1, . . . , n denoting the jth constituent wavelength component of the spectrum, wherein the matrix element a_{i,j} describes the signal intensity of the jth constituent wavelength component at the ith photosensitive element. By way of example, computation and/or application of the signal distribution matrix may be described in further detail in Y. Zong, S. W. Brown, B. C. Johnson, K. R. Lykke and Y. Ohno: “Simple spectral stray light correction method for array spectroradiometers”, Applied Optics, volume 45, number 6, 2006.

The broadband light source may comprise at least one of: an incandescent lamp; a blackbody radiator; an electric filament; a light-emitting diode (LED); a superluminescent diode (SLD); a microelectromechanical systems (MEMS) blackbody radiator. Alternatively or additionally, the broadband light source may comprise a combination of two or more of the aforementioned light emitting devices and/or of at least one of the aforementioned light emitting devices with at least one other light emitting device, for example a combination of two or more LEDs each having different wavelengths and/or a combination of at least one incandescent lamp and at least one LED. The broadband light source may be an internal light source comprised by the spectrometer device or, alternatively, may be an external light source.

A spectral bandwidth of the transmission bands of the narrow band pass filter may be lower than a spectral resolution of the spectrometer device, specifically of the detector device. For example, a spectral bandwidth of the transmission bands of the narrow band pass filter may not exceed 10 nm, specifically 5 nm, more specifically 1 nm. The spectral resolution of the spectrometer device, specifically of the detector device, may be lower than 100 nm, specifically lower than 10 nm, more specifically lower than 5 nm.

In the method, the plurality of detector signals may correspond to a spectrum of the narrow band pass filter, specifically of the plurality of narrow band pass filters, the spectrum comprising a wavelength position of the predetermined transmission bands. The term “correspond” as used herein is a broad term and is to be given its ordinary and customary meaning to a person of ordinary skill in the art and is not to be limited to a special or customized meaning. The term specifically may refer, without limitation, to a partial and/or full equivalence of two or more objects, items of information, properties or the like. Specifically, the plurality of detector signals may be at least partially equivalent to the spectrum of the at least one narrow band pass filter, such as in a specific spectral range, for example in at least a part of one or more of the visible spectral range, the ultraviolet spectral range and/or the infrared spectral range. Alternatively or additionally, the plurality of detector signals may be fully equivalent to the spectrum of the at least one narrow band pass filter, such that the plurality of detector signals may cover the full spectral range of the at least one narrow band pass filter in one or more of the visible spectral range, the ultraviolet spectral range and the infrared spectral range.

The method, specifically step c), may further comprise at least one of:
c.1) determining at least one of a pixel position and an identification number of the plurality of photosensitive elements generating intensity peaks in the plurality of detector signals;
c.2) assigning at least one of the predetermined transmission bands of the narrow band pass filter to the plurality of intensity peaks; and
c.3) determining a wavelength calibration function, wherein the wavelength calibration function assigns at least one of the pixel position and the identification number of the photosensitive elements to a wavelength position.

Specifically, the wavelength calibration function may comprise a polynomial function of degree N, wherein a plurality of at least N+1 intensity peaks may be used. The polynomial function may be or may comprise a function f:f(x)=Σₙ₌₀^{N}aₙxⁿ, wherein f denotes the wavelength or the wavelength band of the photosensitive element having the pixel position or the identification number x and wherein aₙ denotes polynomial coefficients to be determined, for example by using regression analysis. For example, the wavelength calibration function may comprise a polynomial function of degree N=3.

Additionally, the method, specifically step d), may further comprise at least one of:
d.1) processing the plurality of detector signals by applying at least one of an offset correction and a digital filter, specifically a noise filtering technique, to the plurality of detector signals;
d.2) interpolating the plurality of processed detector signals to obtain an illumination intensity at each photosensitive element comprised by the detector device for a plurality of the constituent wavelength components, specifically for each of the constituent wavelength components; and
d.3) generating, by using the interpolated detector signal, a plurality of signal distribution functions, specifically being recorded in the signal distribution matrix.

The method may further comprise applying at least one of the item of wavelength calibration information and the item of stray light calibration information to a measurement spectrum determined by using the spectrometer device. The measurement spectrum may refer to a spectrum of a sample to be analyzed determined by using the spectrometer device. Specifically, applying the item of stray light calibration information may comprise applying an inverse of the signal distribution matrix to the measurement spectrum.

The method may further comprise, specifically prior to step a), determining the transmission bands of the narrow band pass filter, specifically of the plurality of narrow band pass filters, by using a calibrated spectrometer device.

The method may further comprise determining a blue shift correction. The term “blue shift correction” as used herein is a broad term and is to be given its ordinary and customary meaning to a person of ordinary skill in the art and is not to be limited to a special or customized meaning. The term specifically may refer, without limitation, to an additional item of wavelength calibration information, specifically qualifying and/or quantifying a blue shift at the spectrometer device. The blue shift may, as an example, arise due to an effect at the optical element of differently separating the incident light into the spectrum of constituent wavelength components depending on an incident angle of the incident light at the optical element. Specifically, in case a detector device dissembled from the spectrometer device is used for the method for calibrating the spectrometer device, incident light used for calibrating the spectrometer device may have a differing incident angle at the optical element compared to incident light with the detector device assembled in the spectrometer device. Thus, a blue shift may occur having the calibrated detector device assembled in the spectrometer device. For the blue shift correction, a plurality of additional detector signals may be generated having the detector device assembled in the spectrometer device. The blue shift correction may comprise at least one further item of wavelength calibration information determined by repeating step c) using the plurality of additional detector signals. The blue shift correction may comprise at least one item of correction information compensating the blue shift for the assembled detector device, specifically by compensating for the effect of angular dependency at the optical element.

Additionally or alternatively, the method may comprise determining at least one temperature of the detector device. The method may comprise determining at least one of the item of wavelength calibration information and the item of stray light calibration information for a plurality of different temperatures. Depending on environmental operation conditions, different temperatures of the detector device may be required. However, the item of wavelength calibration information and/or the item o stray light calibration information may be dependent on temperature. Thus, determining the item of wavelength calibration information and/or the item of stray light calibration information at the plurality of different temperatures may enable taking into account these temperature effects.

In the method, the item of wavelength calibration information and the item of stray light calibration information may be determined using the same plurality of detector signals. Thus, the method may comprise generating the plurality of detector signals once for determining the two items of calibration information, specifically for the item of wavelength calibration information and the item of stray light calibration information. In principle, no further measurements may be required for calibrating the spectrometer device.

The method may be performed at at least one of a user site and a manufacturer site. Specifically, the method may be performed in-field, i.e. directly at the user site, and/or in-lab, i.e. at the manufacturer site.

The method may be performed using at least one of a disassembled detector device and an assembled detector device. For example, in case the spectrometer device is operated in a transmissive mode, the method may be performed having the detector device assembled in the spectrometer device. In case of a spectrometer device being operated in a reflective mode, the method may be performed having the detector device dissembled from the spectrometer device. However, alternatively or additionally, the detector device for a spectrometer device being operated in a reflective mode may also be used assembled in the spectrometer device. Additionally, the method may further comprise determining at least one correction factor by determining a plurality of detector signals of a reference sample with the at least one detector device assembled in the spectrometer device. Specifically, when performing the method using the detector device disassembled from the spectrometer device, the method may additionally comprise determining the at least one correction factor with the detector device assembled in the spectrometer device. As an example, the correction factor may be determined by comparing the plurality of detector signals of the reference sample with known detector signals of the reference sample.

The method may specifically be computer-implemented, specifically computer-supported or computer-controlled. Referring to the computer-implemented aspects of the invention, one or more of the method steps or even all of the method steps of the method according to one or more of the embodiments disclosed herein may be performed, or at least supported or controlled, by using an evaluation unit of the system, specifically comprising at least one processor. Thus, generally, any of the method steps including provision and/or manipulation of data may be performed by using the evaluation unit. Generally, these method steps may include any of the method steps, typically except for method steps requiring manual work, such as providing the samples and/or certain aspects of performing the actual measurements. Thus, specifically, at least method steps c) and d) may be computer-implemented, wherein, optionally, steps a) and b) may, at least partially, be computer-controlled. Further aspects referring to the computer-implemented aspects of the invention will be outlined in further detail below.

In a further aspect of the present invention, a system for calibrating a spectrometer device is disclosed. The system comprises at least one broadband light source and at least one narrow band pass filter, specifically a plurality of narrow band pass filters, having a plurality of predetermined transmission bands. The system further comprises at least one detector device of a spectrometer device, wherein the detector device is configured for determining a plurality of detector signals depending on an illumination of the detector device, wherein the detector device comprises at least one optical element configured for separating incident light into a spectrum of constituent wavelength components and further comprising a plurality of photosensitive elements. Each photosensitive element is configured for receiving at least a portion of one of the constituent wavelength components and for generating a respective detector signal depending on the illumination of the respective photosensitive element by the at least one portion of the respective constituent wavelength component. The system is configured for performing the method for calibrating a spectrometer device according to the present invention, such as according to any one of the embodiments disclosed above and/or according to any one of the embodiments disclosed in further detail below.

For definitions and embodiments of the system, reference is made to the definitions and embodiments referring to the method for calibrating a spectrometer device.

The optical element may comprise at least one wavelength-selective element. The wavelength-selective element may be selected from the group consisting of: a prism; a grating; a linear variable filter; an optical filter, specifically a narrow band pass filter; an interferometer.

The detector device may specifically comprise the plurality of photosensitive elements arranged in a linear array, wherein the array of photosensitive elements may comprise a number of 10 to 1000, specifically a number of 100 to 500, specifically a number of 200 to 300, more specifically a number of 256, photosensitive elements. Each photosensitive element may be selected, specifically independent from each other, from the group consisting of: a pixelated inorganic camera element, specifically a pixelated inorganic camera chip, more specifically a CCD chip or a CMOS chip; a monochrome camera element, specifically a monochrome camera chip; at least one photoconductor, specifically an inorganic photoconductor, more specifically an inorganic photoconductor comprising PbS, PbSe, Ge, InGaAs, ext. InGaAs, InSb or HgCdTe.

Each photosensitive element may specifically be sensitive for electromagnetic radiation in wavelength range from 760 nm to 1000 μm, specifically in a wavelength range from 760 nm to 15 μm, more specifically in a wavelength range from 1 μm to 5 μm, more specifically in a wavelength range from 1 μm to 3 μm.

The system may comprise at least one evaluation unit. The evaluation unit may specifically comprise one or more processors. The evaluation unit may be configured for performing the method for calibrating a spectrometer device according to the present invention, such as according to any one of the embodiments disclosed above and/or any one of the embodiments disclosed in further detail below. The evaluation unit, specifically the processor, may refer to an arbitrary logic circuitry configured for performing basic operations of a computer or system, and/or, generally, to a device which is configured for performing calculations or logic operations. In particular, the evaluation unit may be configured for processing basic instructions that drive the computer or system. As an example, the evaluation unit may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. In particular, the evaluation unit may be a multi-core processor. Specifically, the evaluation unit may be or may comprise a central processing unit (CPU). Additionally or alternatively, the evaluation unit may be or may comprise a microprocessor, thus specifically the evaluation unit's elements may be contained in one single integrated circuitry (IC) chip. Additionally or alternatively, the evaluation unit may be or may comprise one or more application-specific integrated circuits (ASICs) and/or one or more field-programmable gate arrays (FPGAs) and/or one or more tensor processing units (TPU) and/or one or more chip, such as a dedicated machine learning optimized chip, or the like. The evaluation unit specifically may be configured, such as by software programming, for performing, controlling and/or supporting one or more, in particular all, of the method steps.

The system may comprise at least one spectrometer device, specifically a handheld spectrometer device, comprising the at least one detector device. Thus, as an example, the system may comprise the spectrometer device comprising the detector device assembled therein and the method may be performed with the assembled spectrometer device. However, alternatively, the system may comprise only the detector device of the spectrometer device and the method may be performed with the disassembled detector device.

The spectrometer device may specifically be a handheld spectrometer device. The term “handheld”, as used in the context of the spectrometer device, may specifically refer, without limitation to a property of the spectrometer device capable of being mobile and/or moved by a human user, specifically capable of being carried by a human user, specifically capable of being carried by a human user with a single hand. Specifically, the handheld spectrometer device may be dimensioned for being carried by the human user, e.g. by having extensions in any dimension not exceeding 500 mm, specifically not exceeding 300 mm. Additionally or alternatively, the handheld spectrometer device, for being carried by the human user, may have a weight not exceeding 5 kg, specifically not exceeding 3 kg or even not exceeding 0.5 kg.

As an example, the spectrometer device may specifically comprise the at least one broadband light source. Alternatively or additionally, the broadband light source of the system may be an external broadband light source. As outlined above, the broadband light source may emit light in a broad spectral range, such as light having a spectral width of at least 5 nm, specifically at least 10 nm, e.g. a spectral width of 10 nm to 2000 nm. For example, the broadband light source may emit light in a broad spectral range of 400 nm to 3000 nm. For example, the broadband light source may comprise at least one of: an incandescent lamp; a blackbody radiator; an electric filament; a LED; a SLD; a MEMS blackbody radiator.

The spectrometer device may comprise at least one housing having at least one optically transparent entrance window. The housing of the spectrometer device may refer to an element or a combination of elements which are configured for fully or partially surrounding and/or providing mechanical cover for one or more other elements of the spectrometer device. Thus, as an example, the housing may be or may comprise at least one rigid housing, such as at least one rigid housing made of at least one of a plastic material or a metallic material. The entrance window may refer to an element, such as an optically transparent element made of one or more of glass, quartz, sapphire or a plastic material, or to an opening of the spectrometer device allowing the light to enter the housing.

Additionally, the spectrometer device may comprise at least one further optical element arranged in between the entrance window and the detector device, specifically at least one optical element selected from the group consisting of: an optical lens; a mirror; a reflector; an aperture; a diffractive optical element; a dispersive element; an optical modulator; a polarization filter; a band filter; a liquid crystal display (LCD). The further optical element may specifically be configured for collecting and/or transmitting incident light from the entrance window to the optical element.

In a further aspect of the present invention, a computer program is disclosed comprising instructions which, when the program is executed by an evaluation unit of the system, cause the system as described herein, specifically the evaluation unit of the system, to perform the method for calibrating a spectrometer device according to the present invention, such as according to any one of the embodiments disclosed above and/or any one of the embodiments disclosed in further detail below.

In a further aspect of the present invention, a computer-readable storage medium is disclosed comprising instructions which, when executed by an evaluation unit of the system as described herein, cause the system, specifically the evaluation unit of the system, to perform the method for calibrating a spectrometer device according to the present invention, such as according to any one of the embodiments disclosed above and/or any one of the embodiments disclosed in further detail below.

As used herein, the term “computer-readable storage medium” specifically may refer to non-transitory data storage means, such as a hardware storage medium having stored thereon computer-executable instructions. The computer-readable storage medium specifically may be or may comprise a storage medium such as a random-access memory (RAM) and/or a read-only memory (ROM).

The method and devices according to the present invention may provide a larger number of advantages over known methods and devices. Specifically, the method and devices according to the present invention may involve, for the purpose of calibrating the spectrometer device, using the broadband light source, for example incandescent light sources, light bulbs, blackbody radiators and/or thin electric filaments. These broadband light sources are typically of low cost and easily available. The broadband light source may be part of the spectrometer device itself. Additionally, the method and devices according to the present invention may involve, for the purpose of calibrating the spectrometer device, using a set of narrow band pass filters which specifically may be configured for transmitting light from the broadband light source only in a specific and narrow spectral range. Each of the narrow band pass filters may cover a distinct spectral range. The spectral range of each narrow band pass filter may be predetermined, for example based on spectral high-resolution data obtained with a calibrated standard spectrometer device. The plurality of narrow band pass filters may be combined with one or more neutral density filters for creating light of narrow wavelength bands from the broadband light source with known spectral irradiance. Consecutively, the detector device may determine the signal arising from the plurality of narrow band pass filters. Consecutively, based on the predetermined transmission bands of the narrow band pass filters, the item of wavelength calibration information and the item of stray light calibration information of the spectrometer device may be determined, specifically using computer programs based on the same data.

Further, the method for calibrating a spectrometer device may specifically comprise using narrow band pass filters for determining the item of wavelength calibration information and a computation method to determine the item of stray light calibration information based on the same data. The calibration may be performed either in-lab at the manufacturer's site and/or in-field at the user's site. The system may specifically refer to a setup that allows performing the calibration measurement for both, a wavelength calibration and a stray light calibration, with a final spectrometer device or, alternatively to a setup that enables the calibration measurement on a detector device to be built in a spectrometer device afterwards. An additional method step may comprise determining and/or correcting a blue shift correction dependent on pixel position. All calibrations may be performed at different temperatures of the detector device since, in some cases, a change of the temperature at the detector device is required depending on environmental operation conditions of the spectrometer device. Thus, the item of wavelength calibration information and the item of stray light calibration information may be dependent on the temperature of the detector device, which can be taken into account when performing multiple calibrations at different temperatures.

In contrast to known method and devices, the method and devices according to the present invention may enable determining both items of calibration information, i.e. the item of wavelength calibration information and the item of stray light calibration information, from a single measurement cycle and by using robust and reliable components. The calibration of the spectrometer device may require only two components: a broadband light source and the narrow band pass filter, specifically the plurality of narrow band pass filters, having a plurality of predetermined transmission bands. The method for calibrating a spectrometer device may enable simple and reliable factory calibration as well as simple and reliable in-field calibration. Thus, the user of the spectrometer device may be able to calibrate or re-calibrate his spectrometer device without involving the manufacturer.

Specifically and in contrast to known methods, the method according to the present invention may not require any atomic gauge standards, such as argon pen ray lamps, nor any narrowband light sources, such as monochromators or lasers. Therefore, the method for calibrating a spectrometer device may be applied using easily accessible components, thus, enabling a low cost and low effort calibration. Further, the spectrometer device may be calibrated or recalibrated in the field, which is of particular importance for the mass application of spectroscopic methods. Additionally, the stray light calibration step may improve known methods of calibrating stray light effects by using noise filtering techniques.

The spectrometer device may be operated in transmissive mode, specifically using a light source for illuminating a sample interface and using at least one further optical element for obtaining relative transmission signals from the sample. In this configuration, the system comprising the spectrometer being operated in transmissive mode, the at least one narrow band pass filters may replace the sample to obtain the plurality of detector signals for performing the calibrations. The plurality of detector signals for determining the item of wavelength calibration information and the item of stray light calibration information may be collected at once. In this simple configuration, the method for calibrating the spectrometer device may be used without any further post-processing or additional information.

Alternatively, the spectrometer device may be operated in reflective mode. For performing the method for calibrating the spectrometer device, the spectrometer device may not be finally assembled. The system for calibrating the spectrometer device may only comprise the detector device of the spectrometer device. The method may comprise a reference measurement of a reference sample for the spectrometer device being operated in the reflective mode for determining a raw signal distribution on the detector device. For performing the method, the system may comprise a modified further optical element. The arrangement of the system may not change compared with an optical path of the spectrometer device but the at least one narrow band pass filter may be inserted in the optical path. The at least one narrow band pass filter may be changed automatically in the system in an interchangeably slot. Alternatively or additionally, other transmitting reference samples may be inserted in the interchangeable slot. Measurements using an original spectrometer device configuration may be also possible by inserting no sample or filter into the interchangeable slot.

Alternatively or additionally, the system may comprise the spectrometer device being operated in the reflective mode and comprising the assembled detector device. In this example, the broadband light source of the spectrometer device may not be used. The broadband light source may be turned off constantly and an external broadband light source may be used to perform the method for calibrating the spectrometer device. The light from this broadband light source may be filtered with the at least one narrow band pass filters required for determining the item of wavelength calibration information and the item of stray light calibration information. The system may also be configured for measuring other reference samples or the like.

Summarizing and without excluding further possible embodiments, the following embodiments may be envisaged:

Embodiment 1: A method for calibrating a spectrometer device, wherein the method comprises the following steps:
a) illuminating at least one detector device of the spectrometer device with at least one broadband light source through at least one narrow band pass filter, specifically through a plurality of narrow band pass filters, having a plurality of predetermined transmission bands;
b) generating, by using the detector device, a plurality of detector signals depending on the illumination of step a), wherein the detector device comprises at least one optical element configured for separating incident light into a spectrum of constituent wavelength components and further comprising a plurality of photosensitive elements, wherein each photosensitive element is configured for receiving at least a portion of one of the constituent wavelength components and for generating a respective detector signal depending on the illumination of the respective photosensitive element by the at least one portion of the respective constituent wavelength component;
c) determining at least one item of wavelength calibration information, wherein the item of wavelength calibration information comprises at least one assignment assigning wavelengths, specifically wavelength bands, of incident light to corresponding photosensitive elements being responsive to these wavelengths, specifically assigning at least one of the photosensitive elements to each of the predetermined transmission bands, more specifically assigning one or more of pixel positions and/or identification numbers of the photosensitive elements to the respective predetermined transmission bands, specifically to each of the predetermined transmission bands; and
d) determining at least one item of stray light calibration information based on the plurality of detector signals, wherein the item of stray light calibration information comprises at least one signal distribution function, specifically at least one signal distribution matrix, the signal distribution function describing a distribution of responses of the photosensitive elements to incident light having a specific wavelength.

Embodiment 2: The method according to the preceding embodiment, wherein the broadband light source comprises at least one of: an incandescent lamp; a blackbody radiator; an electric filament; a LED; a SLD; a MEMS blackbody radiator.

Embodiment 3: The method according to any one of the preceding embodiments, wherein a spectral bandwidth of the transmission bands of the narrow band pass filter is lower than a spectral resolution of the spectrometer device.

Embodiment 4: The method according to any one of the preceding embodiments, the plurality of detector signals corresponds to a spectrum of the narrow band pass filter, specifically of the plurality of narrow band pass filters, the spectrum comprising a wavelength position of the predetermined transmission bands.

Embodiment 5: The method according to any one of the preceding embodiments, wherein step c) comprises at least one of:
c.1) determining at least one of a pixel position and an identification number of the plurality of photosensitive elements generating intensity peaks in the plurality of detector signals;
c.2) assigning at least one of the predetermined transmission bands of the narrow band pass filter to the plurality of intensity peaks; and
c.3) determining a wavelength calibration function, wherein the wavelength calibration function assigns at least one of the pixel position and the identification number of the photosensitive elements to a wavelength position.

Embodiment 6: The method according to the preceding embodiment, wherein the wavelength calibration function comprises a polynomial function of degree N, wherein a plurality of at least N+1 intensity peaks is used.

Embodiment 7: The method according to any one of the preceding embodiments, wherein step d) comprises at least one of:
d.1) processing the plurality of detector signals by applying at least one of an offset correction and a digital filter, specifically a noise filtering technique, to the plurality of detector signals;
d.2) interpolating the plurality of processed detector signals to obtain an illumination intensity at each photosensitive element comprised by the detector device for a plurality of the constituent wavelength components, specifically for each of the constituent wavelength components; and
d.3) generating, by using the interpolated detector signal, a plurality of signal distribution functions, specifically being recorded in a signal distribution matrix.

Embodiment 8: The method according to any one of the preceding embodiments, wherein the method further comprises applying at least one of the item of wavelength calibration information and the item of stray light calibration information to a measurement spectrum determined by using the spectrometer device.

Embodiment 9: The method according to the preceding embodiment, wherein applying the item of stray light calibration information comprises applying an inverse of the signal distribution matrix to the measurement spectrum.

Embodiment 10: The method according to any one of the preceding embodiments, wherein the method further comprises, specifically prior to step a), determining the transmission bands of the narrow band pass filter, specifically of the plurality of narrow band pass filters, by using a calibrated spectrometer device.

Embodiment 11: The method according to any one of the preceding embodiments, wherein the method further comprises determining a blue shift correction, wherein, for the blue shift correction, a plurality of additional detector signals is generated having the detector device assembled in the spectrometer device.

Embodiment 12: The method according to the preceding embodiment, wherein the blue shift correction comprises at least one further item of wavelength calibration information determined by repeating step c) using the plurality of additional detector signals.

Embodiment 13: The method according to any one of the preceding embodiments, wherein the method comprises determining at least one temperature of the detector device.

Embodiment 14: The method according to the preceding embodiment, wherein the method comprises determining at least one of the item of wavelength calibration information and the item of stray light calibration information for a plurality of different temperatures.

Embodiment 15: The method according to any one of the preceding embodiments, wherein the item of wavelength calibration information and the item of stray light calibration information are determined using the same plurality of detector signals.

Embodiment 16: The method according to any one of the preceding embodiments, wherein the method is performed at at least one of a user site and a manufacturer site.

Embodiment 17: The method according to any one of the preceding embodiments, wherein the method is performed using at least one of a disassembled detector device and an assembled detector device.

Embodiment 18: The method according to any one of the preceding embodiments, wherein the method further comprises determining at least one correction factor by determining a plurality of detector signals of a reference sample with the at least one detector device assembled in the spectrometer device.

Embodiment 19: The method according to any one of the preceding embodiments, wherein the method is computer-implemented.

Embodiment 20: A system for calibrating a spectrometer device, wherein the system comprises at least one broadband light source and at least one narrow band pass filter, specifically a plurality of narrow band pass filters, having a plurality of predetermined transmission bands, wherein the system further comprises at least one detector device of a spectrometer device, wherein the detector device is configured for determining a plurality of detector signals depending on an illumination of the detector device, wherein the detector device comprises at least one optical element configured for separating incident light into a spectrum of constituent wavelength components and further comprising a plurality of photosensitive elements, wherein each photosensitive element is configured for receiving at least a portion of one of the constituent wavelength components and for generating a respective detector signal depending on the illumination of the respective photosensitive element by the at least one portion of the respective constituent wavelength component, wherein the system is configured for performing the method for calibrating a spectrometer device according to any one of the preceding embodiments referring to a method for calibrating a spectrometer device.

Embodiment 21: The system according to the preceding embodiment, wherein the optical element comprises at least one wavelength-selective element.

Embodiment 22: The system according to the preceding embodiment, wherein the wavelength-selective element is selected from the group consisting of: a prism; a grating; a linear variable filter; an optical filter, specifically a narrow band pass filter; an interferometer.

Embodiment 23: The system according to any one of the three preceding embodiments, wherein the detector device comprises the plurality of photosensitive elements arranged in a linear array, wherein the array of photosensitive elements comprises a number of 10 to 1000, specifically a number of 100 to 500, specifically a number of 200 to 300, more specifically a number of 256, photosensitive elements.

Embodiment 24: The system according to any one of the four preceding embodiments, wherein each photosensitive element is selected from the group consisting of: a pixelated inorganic camera element, specifically a pixelated inorganic camera chip, more specifically a CCD chip or a CMOS chip; a monochrome camera element, specifically a monochrome camera chip; at least one photoconductor, specifically an inorganic photoconductor, more specifically an inorganic photoconductor comprising PbS, PbSe, Ge, InGaAs, ext. InGaAs, InSb or HgCdTe.

Embodiment 25: The system according to any one of the five preceding embodiments, wherein each photosensitive element is sensitive for electromagnetic radiation in wavelength range from 760 nm to 1000 μm, specifically in a wavelength range from 760 nm to 15 μm, more specifically in a wavelength range from 1 μm to 5 μm, more specifically in a wavelength range from 1 μm to 3 μm.

Embodiment 26: The system according to any one of the six preceding embodiments, wherein the system comprises at least one evaluation unit, wherein the evaluation unit comprises one or more processors, wherein the evaluation unit is configured for performing the method for calibrating a spectrometer device according to any one of the preceding embodiments referring to a method for calibrating a spectrometer device.

Embodiment 27: The system according to any one of the seven preceding embodiments, wherein the system comprises at least one spectrometer device, specifically a handheld spectrometer device, comprising the at least one detector device.

Embodiment 28: The system according to the preceding embodiment, wherein the spectrometer device comprises the at least one broadband light source.

Embodiment 29: The system according to any one of the two preceding embodiments, wherein the spectrometer device comprises at least one housing having at least one optically transparent entrance window.

Embodiment 30: The system according to the preceding embodiment, wherein the spectrometer device comprises at least one further optical element arranged in between the entrance window and the detector device, specifically at least one optical element selected from the group consisting of: an optical lens; a mirror; a reflector; an aperture; a diffractive optical element; a dispersive element; an optical modulator; a polarization filter; a band filter; a liquid crystal display (LCD).

Embodiment 31: A computer program comprising instructions which, when the program is executed by an evaluation unit of the system according to any one of the preceding embodiments referring to a system, cause the system, specifically the evaluation unit of the system, to perform the method for calibrating a spectrometer device according to any one of the preceding embodiments referring to a method for calibrating a spectrometer device.

Embodiment 32: A computer-readable storage medium comprising instructions which, when executed by an evaluation unit of the system according to any one of the preceding embodiments referring to a system, cause the system, specifically the evaluation unit of the system, to perform the method for calibrating a spectrometer device according to any one of the preceding embodiments referring to a method for calibrating a spectrometer device.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIGS. 1 to 3 show embodiments of a system for calibrating a spectrometer device in a schematic view;

FIGS. 4 and 5 show flow charts of embodiments of a method for calibrating a spectrometer device;

FIGS. 6A to 6D show diagrams of a stray light calibration;

FIG. 7 shows a flow chart of an embodiment of a method for calibrating a spectrometer device by using a system according to FIG. 2; and

FIG. 8 shows a flow chart of an embodiment of a method for calibrating a spectrometer device by using a system according to FIG. 3.

### DETAILED DESCRIPTION OF THE EMBODIMENTS

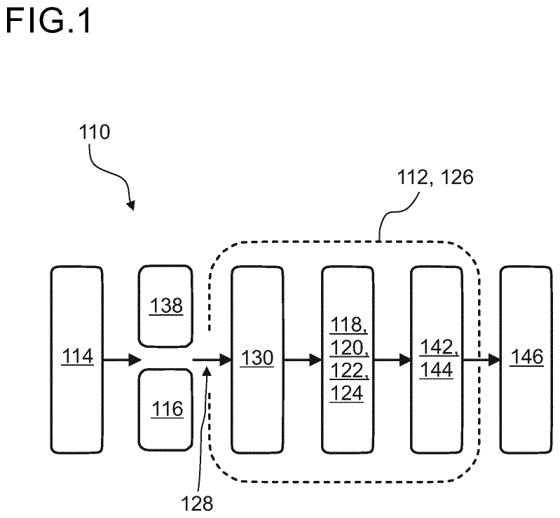

FIGS. 1 to 3 show exemplary embodiments of a system 110 for calibrating a spectrometer device 112 in a schematic view. In the following, FIGS. 1 to 3 are described in combination. The system 110 comprises at least one broadband light source 114, at least one narrow band pass filter 116, specifically a plurality of narrow band pass filters 116, having a plurality of predetermined transmission bands and at least one detector device 118 of the spectrometer device 112.

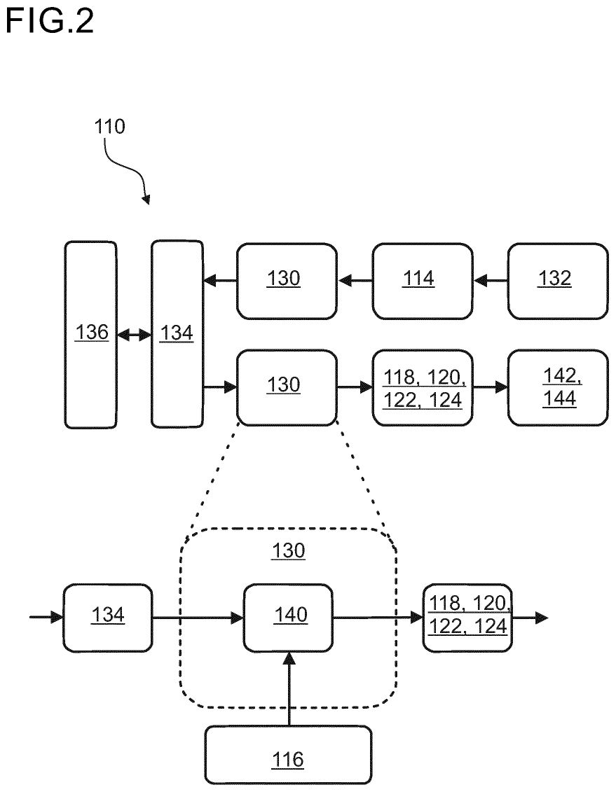

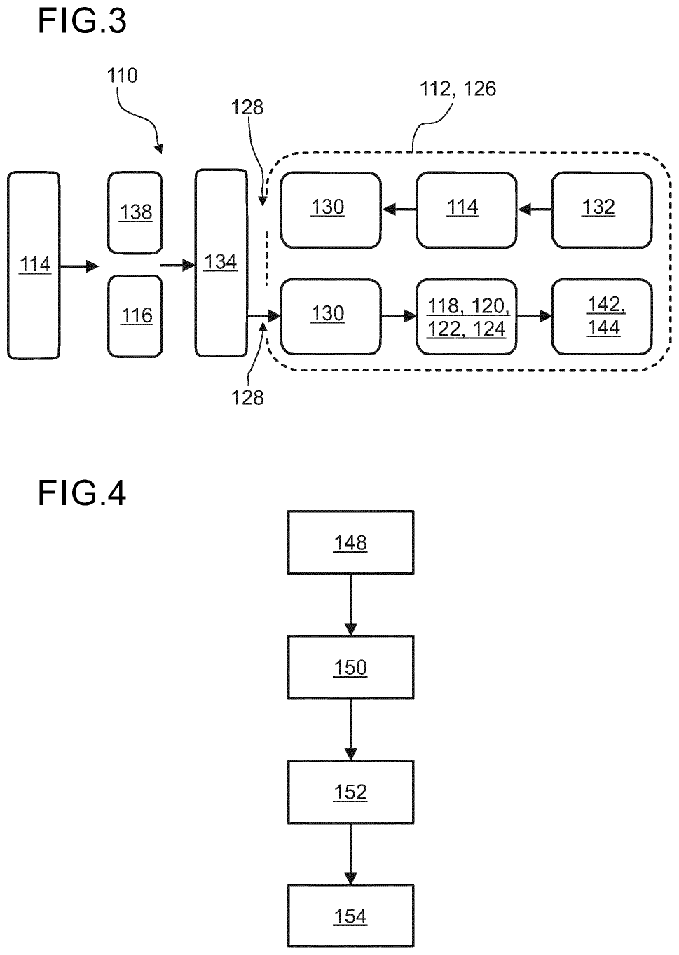

The system 110, as an example, may comprise the spectrometer device 112. The exemplary embodiment of the system 110 shown in FIG. 1 may comprise the spectrometer device 112 comprising the detector device 118 and being operated in transmissive mode. The exemplary embodiment of the system 110 shown in FIG. 3 may comprise the spectrometer device 112 comprising the detector device 118 and being operated in reflective mode. However, alternatively, the exemplary embodiment of the system 110 shown in FIG. 2 may comprise only the detector device 118 disassembled from the spectrometer device 112.

The detector device 118 is configured for determining a plurality of detector signals depending on an illumination of the detector device 118. The detector device 118 comprises at least one optical element 120 configured for separating incident light into a spectrum of constituent wavelength components and further comprising a plurality of photosensitive elements 122. Each photosensitive element (not shown in the Figures) is configured for receiving at least a portion of one of the constituent wavelength components and for generating a respective detector signal depending on the illumination of the respective photosensitive element by the at least one portion of the respective constituent wavelength component.

The optical element 120 may comprise at least one wavelength-selective element 124. The wavelength-selective element 124 may be selected from the group consisting of: a prism; a grating; a linear variable filter; an optical filter, specifically a narrow band pass filter; an interferometer.

As shown in FIGS. 1 and 3, the spectrometer device 112 may comprise at least one housing 126 having at least one optically transparent entrance window 128. The housing 126 of the spectrometer device 112 may refer to an element or a combination of elements which are configured for fully or partially surrounding and/or providing mechanical cover for one or more other elements of the spectrometer device 112. Thus, as an example, the housing 126 may be or may comprise at least one rigid housing, such as at least one rigid housing made of at least one of a plastic material or a metallic material. The entrance window 128 may refer to an element, such as an optically transparent element made of one or more of glass, quartz, sapphire or a plastic material, or to an opening of the spectrometer device 112 allowing the light to enter the housing 126.

Additionally, the spectrometer device 112 may comprise at least one further optical element 130 arranged in between the entrance window 128 and the detector device 118, specifically at least one optical element selected from the group consisting of: an optical lens; a mirror; a reflector; an aperture; a diffractive optical element; a dispersive element; an optical modulator; a polarization filter; a band filter; a liquid crystal display (LCD). The further optical element 130 may specifically be configured for collecting and/or transmitting incident light from the entrance window 128 to the optical element 120.

The broadband light source 114 may be comprised by the spectrometer device 112 or, alternatively or additionally, may be an external broadband light source. The broadband light source 114 may comprise at least one of: an incandescent lamp; a blackbody radiator; an electric filament; a LED; a SLD; a MEMS blackbody radiator. As shown in FIGS. 1 to 3, the broadband light source 114 may be arranged in the system 110 to illuminate the detector device 118 through the narrow band pass filter 116, specifically through the plurality of narrow band pass filters 116.

As can be seen in the exemplary embodiments of FIGS. 2 and 3, the spectrometer device 112 comprising the broadband light source 114 and/or the system 110 may additionally comprise at least one electronic driver device 132 for driving the broadband light source 114 and at least one additional further optical element 130 for collecting and/or transmitting light from the broadband light source 114 to a sample interface 134 of a reference sample 136.

In case the system 110 comprises the spectrometer device 112 as shown in FIGS. 1 and 3, the at least one narrow band pass filter 116, specifically the plurality of narrow band pass filters 116, may be arranged in between the broadband light source 114 and the spectrometer device 112, specifically the entrance window 128. In this example, the at least one narrow band pass filter 116, specifically the plurality of narrow band pass filters 116, may replace a sample to be analyzed 138. Alternatively, however, in case the system 110 only comprises the disassembled detector device 118 as shown in FIG. 2, the at least one narrow band pass filter 116, specifically the plurality of narrow band pass filters 116, may replace the further optical element 130, specifically by in a slot 140 for inserting interchangeable samples, such as reference samples, no samples and/or the at least one narrow band pass filter 116.

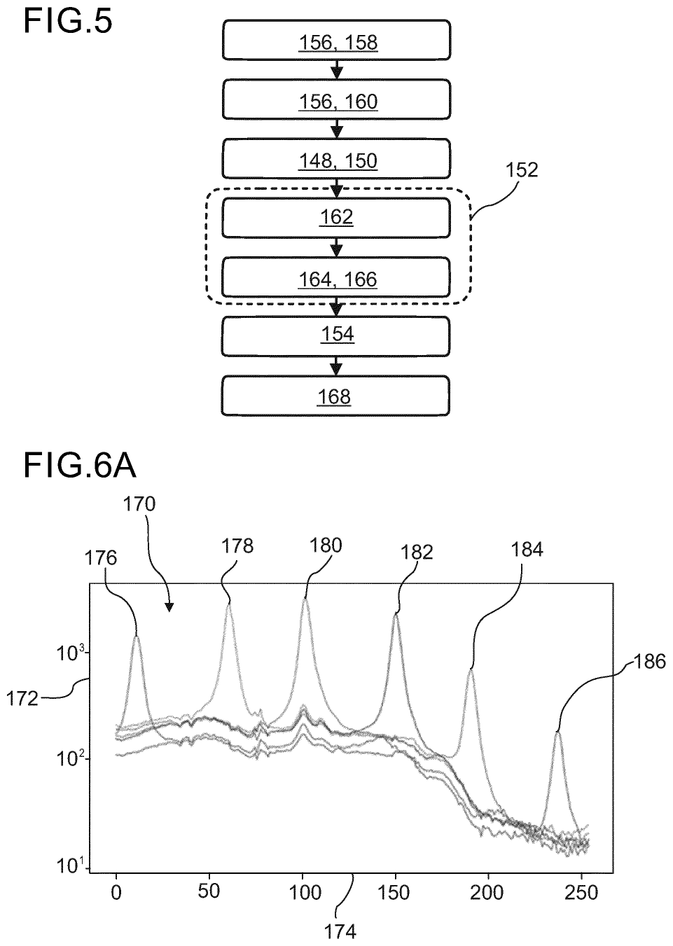

The system 110 is configured for performing the method for calibrating a spectrometer device 112 according to the present invention, such as according to any one of the embodiments described in FIGS. 4, 5, 7 and 8 and/or according to any other embodiments disclosed herein. Specifically, the system 110 may comprise at least one evaluation unit 142. The evaluation unit 142 may specifically comprise one or more processors 144. The evaluation unit 142 may be configured for performing the method for calibrating a spectrometer device 112 according to the present invention, such as according to any one of the embodiments described in FIGS. 4, 5, 7 and 8 and/or according to any other embodiments disclosed herein. The evaluation unit 142 may further be configured for transmitting data, such as optical data, for example measured optical data, to a computer device 146, via a wired and/or a wireless interface.

FIG. 4 shows a flow chart of a first exemplary embodiment of a method for calibrating the spectrometer device 112. The method comprises the following steps which, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises the following steps:
a) (denoted by reference number 148) illuminating the at least one detector device 118 of the spectrometer device 112 with the at least one broadband light source 114 through the at least one narrow band pass filter 116, specifically through the plurality of narrow band pass filters 116, having the plurality of predetermined transmission bands;
b) (denoted by reference number 150) generating, by using the detector device 118, a plurality of detector signals depending on the illumination of step a), wherein the detector device 118 comprises the at least one optical element 120 configured for separating incident light into a spectrum of constituent wavelength components and further comprising the plurality of photosensitive elements 122, wherein each photosensitive element is configured for receiving at least a portion of one of the constituent wavelength components and for generating a respective detector signal depending on the illumination of the respective photosensitive element by the at least one portion of the respective constituent wavelength component;
c) (denoted by reference number 152) determining at least one item of wavelength calibration information, wherein the item of wavelength calibration information comprises at least one assignment assigning wavelengths, specifically wavelength bands, of incident light to corresponding photosensitive elements being responsive to these wavelengths, specifically assigning at least one of the photosensitive elements to each of the predetermined transmission bands, more specifically assigning one or more of pixel positions and/or identification numbers of the photosensitive elements to the respective predetermined transmission bands, specifically to each of the predetermined transmission bands; and
d) (denoted by reference number 154) determining at least one item of stray light calibration information based on the plurality of detector signals, wherein the item of stray light calibration information comprises at least one signal distribution function, specifically at least one signal distribution matrix, the signal distribution function describing a distribution of responses of the photosensitive elements to incident light having a specific wavelength.

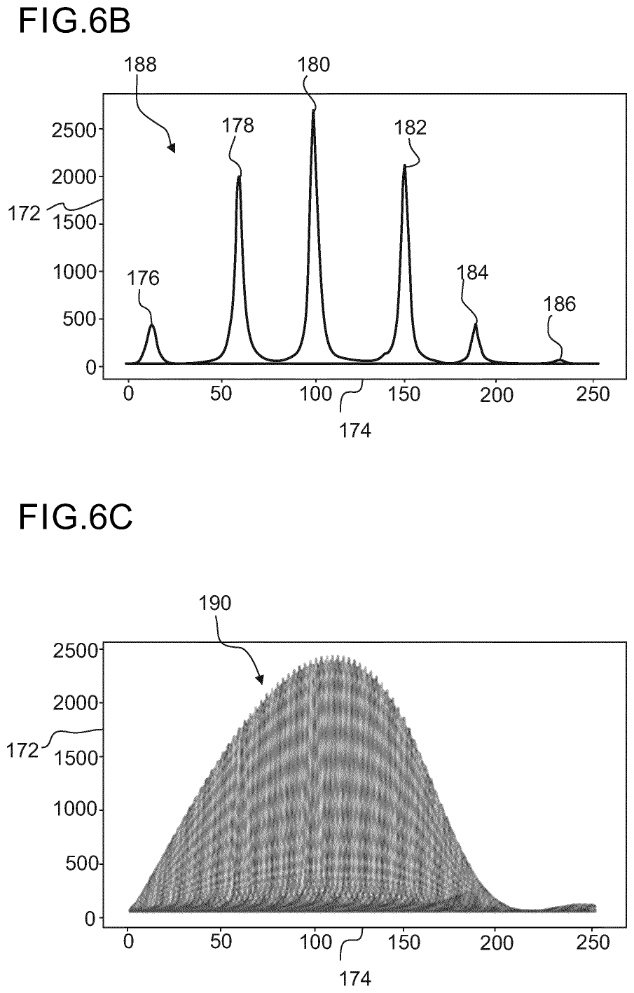

For further possible embodiments of the method, reference is made to FIGS. 5, 7 and 8.

In FIG. 5, a flow chart of a second exemplary embodiment of a method for calibrating the spectrometer device 112 is shown. As shown in FIG. 5, the method may further comprise, specifically prior to step a), determining the transmission bands of the narrow band pass filter 116, specifically of the plurality of narrow band pass filters 116, by using a calibrated spectrometer device 112 (denoted by reference number 156). For example, determining the transmission bands of the narrow band pass filter 116 may comprise determining a spectrum of the narrow band pass filter 116 using the calibrated spectrometer device 112 (denoted by reference number 158) and determining at least one spectral range of the narrow band pass filter 116 (denoted by reference number 160).

The method further comprises step a) (denoted by reference number 148), i.e. illuminating the at least one detector device 118 of the spectrometer device 112 with the at least one broadband light source 114 through the at least one narrow band pass filter 116, and step b) (denoted by reference number 150), i.e. generating, by using the detector device 118, a plurality of detector signals depending on the illumination of step a).

As shown in FIG. 5, the method, specifically step c) (denoted by reference number 152), may further comprise:
c.1) (denoted by reference number 162) determining at least one of a pixel position and an identification number of the plurality of photosensitive elements 122 generating intensity peaks in the plurality of detector signals;
c.2) (denoted by reference number 164) assigning at least one of the predetermined transmission bands of the narrow band pass filter 116 to the plurality of intensity peaks; and
c.3) (denoted by reference number 166) determining a wavelength calibration function, wherein the wavelength calibration function assigns at least one of the pixel position and the identification number of the photosensitive elements to a wavelength position.

Specifically, the wavelength calibration function may comprise a polynomial function of degree N, wherein a plurality of at least N+1 intensity peaks may be used. The polynomial function may be or may comprise a function f:f(x)=Σₙ₌₀^{N}aₙxⁿ, wherein f denotes the wavelength or the wavelength band of the photosensitive element having the pixel position or the identification number x and wherein aₙ denotes polynomial coefficients to be determined, for example by using regression analysis. For example, the wavelength calibration function may comprise a polynomial function of degree N=3.

As outlined above, the method further comprises step d) (denoted by reference number 154), i.e. determining the at least one item of stray light calibration information based on the plurality of detector signals. As can be seen in FIG. 5, the method may further comprise applying at least one of the item of wavelength calibration information and the item of stray light calibration information to a measurement spectrum determined by using the spectrometer device 112 (denoted by reference number 168). The measurement spectrum may refer to a spectrum of the sample to be analyzed 138 determined by using the spectrometer device 112. Specifically, applying the item of stray light calibration information may comprise applying an inverse of the signal distribution matrix to the measurement spectrum.

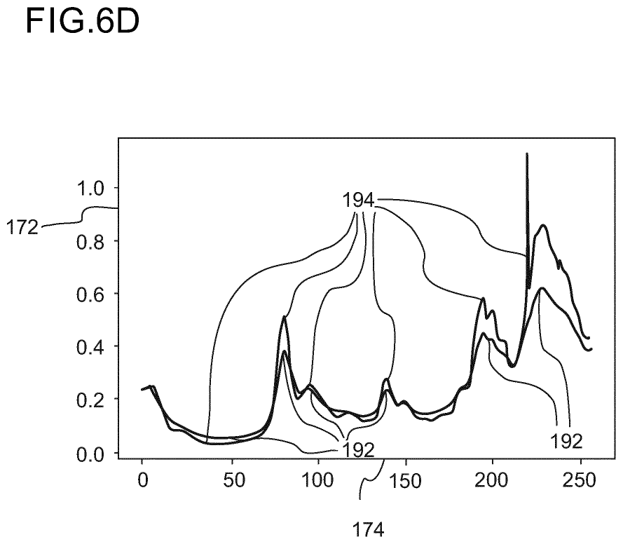

In FIGS. 6A to 6D, diagrams of the stray light calibration, specifically corresponding to different sub-steps of the determining the item of stray light calibration information as performed in step d), are shown. In FIG. 6A, the plurality of detector signals 170 generated by using the detector device 118 depending on the illumination of the detector device 118 with the broadband light source 114 through the at least one narrow band pass filter 116 can be seen. Specifically, in the diagram of FIG. 6A, a signal intensity 172 of the plurality of detector signals 170 is shown as a function of a pixel position 174. In this example, the plurality of narrow band pass filters 116 may comprise six narrow band pass filters 116. However, other numbers of narrow band pass filters 116 are also feasible. The plurality of detector signals 170 for one of the narrow band pass filters 116 may also be referred to as a line spread function (LSF) of the narrow band pass filter 116. In the example of FIG. 6, the plurality of detector signals 170 for a narrow band pass filter 116 having a transmission band at 1456 nm (denoted by reference number 176), for a narrow band pass filter 116 having a transmission band at 1664 nm (denoted by reference number 178), for a narrow band pass filter 116 having a transmission band at 1840 nm (denoted by reference number 180), for a narrow band pass filter 116 having a transmission band at 2057 nm (denoted by reference number 182), for a narrow band pass filter 116 having a transmission band at 2241 nm (denoted by reference number 184) and for a narrow band pass filter 116 having a transmission band at 2446 nm (denoted by reference number 186) is shown. A spectral bandwidth of the transmission bands of the narrow band pass filter 116 may preferably be lower than a spectral resolution of the spectrometer device 112. The plurality of detector signal 170 as shown in FIG. 6A may be used as input data for determining the item of wavelength calibration information and/or the item of stray light calibration information.

The method, specifically step d), may further comprise step d.1), i.e. processing the plurality of detector signals 170 by applying at least one of an offset correction and a digital filter, specifically a noise filtering technique, to the plurality of detector signals 170. In FIG. 6B, the diagram shows the processed plurality of detector signals 188, specifically after applying an offset correction and a digital filter, for example a Savitzky-Golay filter, to the plurality of detector signal 170 as shown in FIG. 6A. Specifically, in the diagram of FIG. 6B, the signal intensity 172 of the plurality of processed detector signals 188 is shown as a function of the pixel position 174. Thus, method step d.1) may comprise processing the line spread functions of the at least one narrow band pass filter 116.

The method, specifically step d), may further comprise step d.2), i.e. interpolating the plurality of processed detector signals 188 to obtain an illumination intensity at each photosensitive element comprised by the detector device 118 for a plurality of the constituent wavelength components, specifically for each of the constituent wavelength components. FIG. 6C shows the interpolated detector signal 190, specifically the intensity 172 of the interpolated detector signal 190 as a function of the pixel position 174. Thus, method step d.2) may comprise determining a spectral response at an arbitrary pixel position 174 using an interpolation of spectral shape and an interpolation of peak amplitudes using linear interpolation of neighboring transmission peaks. The values of the interpolated detector signal 190 may be stored in a so-called signal distribution function (SDF) matrix.

Thus, the method, specifically step d), may further comprise step d.3), i.e. generating, by using the interpolated detector signal 190, a plurality of signal distribution functions, specifically being recorded in the signal distribution matrix. The plurality of signal distribution functions, specifically the signal distribution matrix, may be used for correcting a measurement spectrum of the spectrometer device 112 for stray light, specifically, by applying an inverse of the signal distribution functions, specifically of the signal distribution matrix, to the measurement spectrum, as described in more detail in Y. Zong, S. W. Brown, B. C. Johnson, K. R. Lykke and Y. Ohno: “Simple spectral stray light correction method for array spectroradiometers”, Applied Optics, volume 45, number 6, 2006. The effect of the applying the item of stray light calibration information on a measurement spectrum is shown in FIG. 6D. In FIG. 6D, an uncorrected measurement spectrum 192 of a PET sample and the corresponding corrected measurement spectrum 194 obtained by applying the item of stray light calibration information to the uncorrected measurement spectrum 192 is shown. As can be seen in FIG. 6D, applying of the item of stray light calibration information may increase the spectral resolution and reduce the influence of stray light.

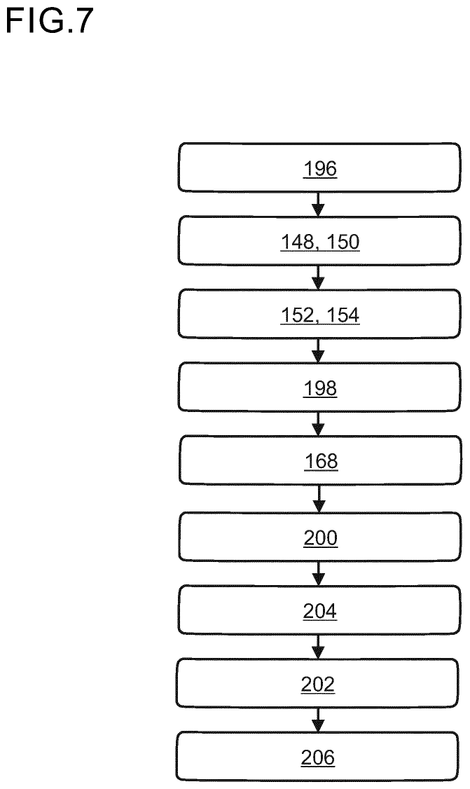

In FIG. 7, a flow chart of an embodiment of a method for calibrating the spectrometer device 112 by using the system 110 according to FIG. 2 is shown. In the exemplary embodiment shown in FIG. 7, the method may comprise performing method steps a) to d) with the detector device 118 disassembled from the spectrometer device 112 and being arranged in the system 110 according to FIG. 2. Thus, the method may comprise, as a first step (denoted by reference number 196), inserting the detector device 118 into the system 110. This first method step may be followed by method steps a) (denoted by reference number 148), i.e. illuminating the at least one detector device 118 of the spectrometer device 112 with the at least one broadband light source 114 through the at least one narrow band pass filter 116, and b) (denoted by reference number 150), i.e. generating, by using the detector device 118, the plurality of detector signals 170 depending on the illumination of step a). Further in this exemplary embodiment, method steps c) (denoted by reference number 152), i.e. determining the at least one item of wavelength calibration information, and d) (denoted by reference number 154), i.e. determining the at least one item of stray light calibration information, may be performed subsequently.

As shown in FIG. 7, the method may further comprise assembling the detector device 118 in the spectrometer device 112 (denoted by reference number 198). Further, the method may comprise applying at least one of the item of wavelength calibration and the item of stray light calibration information to a measurement spectrum determined by using the spectrometer device 112 (denoted by reference number 168). Subsequently, the method may comprise determining a plurality of detector signals of at least one reference sample 136 with a calibrated detector device 118 (denoted by reference number 200). The same reference sample 136 may be used for subsequent method steps. The method may further comprise (denoted by reference number 202) determining at least one correction factor by (denoted by reference number 204) determining a plurality of detector signals of the reference sample 136 with the detector device 118 assembled in the spectrometer device 112. As an example, the correction factor may be determined by comparing the plurality of detector signals of the reference sample 136 with a known detector signals of the reference sample 136. The correction factor may be applied to any subsequent calibration measurements (denoted by reference number 206). The correction factor may improve the accuracy of the item of stray light calibration information.

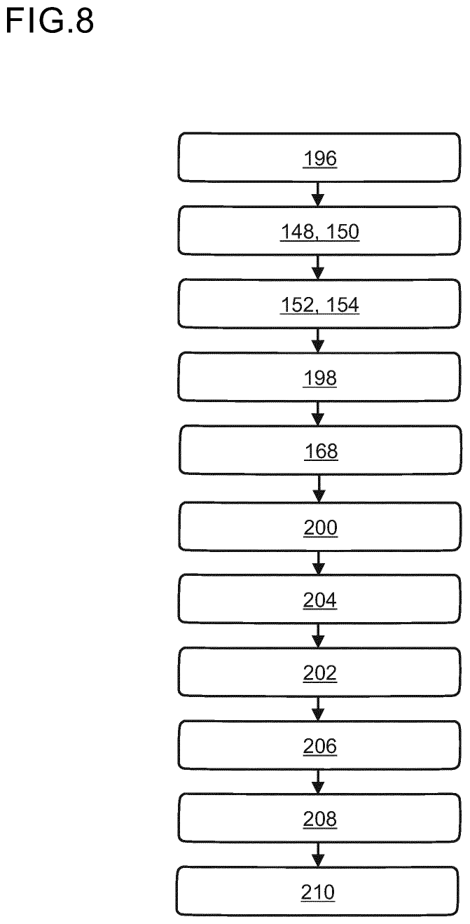

FIG. 8 shows a flow chart of an embodiment of a method for calibrating the spectrometer device 112 by using the system 110 according to FIG. 3. The exemplary embodiment of FIG. 8 may widely correspond to the exemplary embodiment shown in FIG. 7. Thus, for a description of FIG. 8, reference may be made to the description of FIG. 7.

Additionally, the method as shown in FIG. 8 may comprise (denoted by reference number 208) determining a blue shift correction, wherein, for the blue shift correction, a plurality of additional detector signals may be generated having the detector device 118 assembled in the spectrometer device 112. The blue shift correction may comprise at least one further item of wavelength calibration information (denoted by reference number 210) determined by repeating step c) using the plurality of additional detector signals. The blue shift correction may improve the wavelength calibration, specifically for spectrometer devices 112 operated in reflective mode, by accounting for an angular effect of the illumination of the detector device 118 with an external broadband light source 114.

### LIST OF REFERENCE NUMBERS

110 system
112 spectrometer device
114 broadband light source
116 narrow band pass filter
118 detector device
120 optical element
122 plurality of photosensitive elements
124 wavelength-selective element
126 housing
128 entrance window
130 further optical element
132 electronic driver device
134 sample interface
136 reference sample
138 sample to be analyzed
140 slot
142 evaluation unit
144 processors
146 computer device
148 illuminating at least one detector device
150 generating a plurality of detector signals
152 determining at least one item of wavelength calibration information
154 determining at least one item of stray light calibration information
156 determining the transmission bands of the narrow band pass filter
158 determining a spectrum of the narrow band pass filter
160 determining at least one spectral range of the narrow band pass filter
162 determining at least one of a pixel position and an identification number of the plurality of photosensitive elements
164 assigning at least one of the predetermined transmission bands of the narrow band pass filter to the plurality of intensity peaks
166 determining a wavelength calibration function
168 applying at least one of the item of wavelength calibration information and the item of stray light calibration information to a measurement spectrum
170 plurality of detector signals
172 signal intensity
174 pixel position
176 transmission band at 1456 nm
178 transmission band at 1664 nm
180 transmission band at 1840 nm
182 transmission band at 2057 nm
184 transmission band at 2241 nm
186 transmission band at 2446 nm
188 plurality of processed detectors signals
190 interpolated detector signal
192 uncorrected measurement spectrum
194 corrected measurement spectrum
196 inserting the detector device
198 assembling the detector device in the spectrometer device
200 determining a plurality of detector signals of a reference sample with a calibrated detector device
202 determining at least one correction factor
204 determining a plurality of detector signals of the reference sample with the detector device assembled in the spectrometer device
206 apply the correction factor
208 determining a blue shift correction
210 determining a further item of wavelength calibration information

1. A method for calibrating a spectrometer device, wherein the method comprises the following steps:
a) illuminating at least one detector device of the spectrometer device with at least one broadband light source through at least one narrow band pass filter having a plurality of predetermined transmission bands;
b) generating, by using the detector device, a plurality of detector signals depending on the illumination of step a), wherein the detector device comprises at least one optical element configured for separating incident light into a spectrum of constituent wavelength components and further comprising a plurality of photosensitive elements, wherein each photosensitive element is configured for receiving at least a portion of one of the constituent wavelength components and for generating a respective detector signal depending on the illumination of the respective photosensitive element by the at least one portion of the respective constituent wavelength component;
c) determining at least one item of wavelength calibration information, wherein the item of wavelength calibration information comprises at least one assignment assigning wavelengths of incident light to corresponding photosensitive elements being responsive to these wavelengths; and
d) determining at least one item of stray light calibration information based on the plurality of detector signals, wherein the item of stray light calibration information comprises at least one signal distribution function, the signal distribution function describing a distribution of responses of the photosensitive elements to incident light having a specific wavelength,
wherein the item of wavelength calibration information and the item of stray light calibration information are determined using the same plurality of detector signals.

2. The method according to claim 1, wherein the broadband light source comprises at least one of: an incandescent lamp; a blackbody radiator; an electric filament; a LED; a SLD; or a MEMS blackbody radiator.

3. The method according to claim 1, wherein step c) comprises at least one of:
c.1) determining at least one of a pixel position and an identification number of the plurality of photosensitive elements generating intensity peaks in the plurality of detector signals;
c.2) assigning at least one of the predetermined transmission bands of the narrow band pass filter to the plurality of intensity peaks; or
c.3) determining a wavelength calibration function, wherein the wavelength calibration function assigns at least one of the pixel position and the identification number of the photosensitive elements to a wavelength position.

4. The method according to claim 1, wherein step d) comprises at least one of:
d.1) processing the plurality of detector signals by applying at least one of an offset correction and a digital filter to the plurality of detector signals;
d.2) interpolating the plurality of processed detector signals to obtain an illumination intensity at each photosensitive element comprised by the detector device for a plurality of the constituent wavelength components; or
d.3) generating, by using the interpolated detector signal, a plurality of signal distribution functions.

5. The method according to claim 1, wherein the method further comprises applying at least one of the item of wavelength calibration information and the item of stray light calibration information to a measurement spectrum determined by using the spectrometer device.

6. The method according to claim 1, wherein the method further comprises determining the transmission bands of the narrow band pass filter by using a calibrated spectrometer device.

7. The method according to claim 1, wherein the method further comprises determining a blue shift correction, wherein, for the blue shift correction, a plurality of additional detector signals is generated having the detector device assembled in the spectrometer device, wherein the blue shift correction comprises at least one further item of wavelength calibration information determined by repeating step c) using the plurality of additional detector signals.

8. The method according to claim 1, wherein the method comprises determining at least one temperature of the detector device, wherein the method comprises determining at least one of the item of wavelength calibration information and the item of stray light calibration information for a plurality of different temperatures.

9. The method according to claim 1, wherein the method further comprises determining at least one correction factor by determining a plurality of detector signals of a reference sample with the at least one detector device assembled in the spectrometer device.

10. A system for calibrating a spectrometer device, wherein the system comprises at least one broadband light source and at least one narrow band pass filter having a plurality of predetermined transmission bands, wherein the system further comprises at least one detector device of a spectrometer device, wherein the detector device is configured for determining a plurality of detector signals depending on an illumination of the detector device, wherein the detector device comprises at least one optical element configured for separating incident light into a spectrum of constituent wavelength components and further comprising a plurality of photosensitive elements, wherein each photosensitive element is configured for receiving at least a portion of one of the constituent wavelength components and for generating a respective detector signal depending on the illumination of the respective photosensitive element by the at least one portion of the respective constituent wavelength component, wherein the system is configured for performing the method for calibrating a spectrometer device according to claim 1.

11. The system according to claim 10, wherein the optical element comprises at least one wavelength-selective element, wherein the wavelength-selective element is selected from the group consisting of: a prism; a grating; a linear variable filter; an optical filter, a narrow band pass filter; and an interferometer.

12. The system according to claim 10, wherein the system comprises at least one evaluation unit, wherein the evaluation unit comprises one or more processors.

13. The system according to claim 10, wherein the system comprises at least one spectrometer device comprising the at least one detector device.

14. A non-transitory computer-readable storage medium comprising instructions which, when executed by an evaluation unit of a system, causes the system to perform the method for calibrating a spectrometer device according to claim 1.

15. The method according to claim 4, wherein step d.3) comprises generating, by using the interpolated detector signal, a plurality of signal distribution functions recorded in a signal distribution matrix.

16. The system for calibrating a spectrometer device according to claim 10, wherein the at least one narrow band pass filter comprises a plurality of narrow band pass filters.
